(19) United States
(12) Patent Application Publication
(10) Pub. No.: US 2011/0198853 A1
(43) Pub. Date: Aug. 18, 2011

(54) Marine Turbine

(76) Inventors: Ian Masters, Swansea (GB); James Orme, Southampton (GB)

(21) Appl. No.: 13/126,516

(22) PCT Filed: Oct. 21, 2009
(86) PCT No.: PCT/GB2009/002512

§ 371 Date: Apr. 28, 2011

(30) Foreign Application Priority Data
Oct. 31, 2008 (GB) 0819971.3

(51) Int. Cl. F03B 13/10

(52) U.S. Cl. 290/54

(57) ABSTRACT

The present invention relates to a turbine for location of fluid flow. Aspects of the present invention aim to overcome the problems associated with complex marine turbines and provide a simple, robust and economic design. The blades may be located downstream of the turbine body and means are provided to enable relative rotational movement between the support and the turbine such that the turbine aligns with the fluid flow and at least one bearing is configured to be in contact with the fluid. There may also be provided an electrical connection means that comprises a first connection element for rotation with the turbine and a second element connection arranged to be non-rotating and be connected to the cable to a remote location. There may also be provided a support arranged to be fixedly connected to the ground in fluid flow, wherein the support comprises an elongate member having a top end and a bottom end, the portion of the support adjacent the top end having a reduced cross sectional area to the bottom end. There may also be a generator for a marine turbine comprising a rotor arrangement and stator arrangement wherein the generator is flooded with fluid in which the marine turbine is immersed. Additionally or alternatively, the rotor and/or the stator is provided with a matrix, layer and/or coating to provide a fluid sealing function. There may also be provided an axial load bearing assembly including a braking means arranged to control rotation of the shaft.

### BACKGROUND OF THE INVENTION

1. Field of the Invention

The present invention relates to a turbine for the location of fluid flow.

2. State of the Art

With increasing awareness of the effects of the use of traditional energy forms for power production and the reducing supply of fossil fuels, renewable energy is becoming an increasingly important field of development. Renewable energy systems currently being implemented include wind, tidal and solar for example. Tidal power in particular is believed to be a suitable form of renewable energy as it is a renewable resource having limited ecological impact.

Ocean energy systems from both wave and tidal power have been proposed, however, the cost overhead is high due to the complexity of the system and the maintenance required to keep them operational at high efficiency. For example, marine turbines previously proposed require complex sealing systems to protect their bearings and electronics, and further require a system of pitch motor or motors, pitch controllers and pitch bearings. These components can be built to high integrity, but there is still an inherent maintenance requirement that results in expensive operations often requiring offshore vessels.

### SUMMARY OF THE INVENTION

Aspects of the present invention aim to overcome the problems associated with complex marine turbines and provide a simple, robust and economic design.

According to a first aspect of the present invention, there is a marine turbine arranged to be supported in a fluid flow on a support, the turbine comprising a rotatably mounted shaft carrying a plurality of blades, and at least one bearing arranged to support the shaft and a generator arrangement including a rotor coupled with the shaft, and a stator, the turbine, when in use, arranged such that the blades are located downstream of the turbine body, the turbine further comprising means to enable relative rotational movement between the support and the turbine such that the turbine aligns with the fluid flow, wherein the at least one bearing is configured to be in contact with the fluid.

The at least one bearing is preferably a polymer bearing. The forward and rearward bearing assemblies are beneficially located forward and rearward of the generator, the forward bearing assembly beneficially located further from the blades than the rearward bearing.

A braking means may be provided, arranged to control rotation of the shaft. The braking means is beneficially arranged to communicate with the forward bearing assembly. Even more beneficially, the forward bearing assembly includes a bearing and brake disc.

There is beneficially further provided a cowling arranged to cover a plurality of the components of the turbine, the cowling having at least one aperture therein for enabling fluid to enter the cowling. A filter means may be provided, arranged to filter objects from the fluid preventing entry to the at least one apertures.

The turbine may include a rotor arrangement and a stator arrangement, the turbine arranged such that, when in use, fluid floods the separation between rotor arrangement and stator arrangement.

The turbine may include a rotor arrangement and a stator arrangement, wherein the rotor arrangement and/or the stator arrangement is provided with a matrix, layer and/or coating to provide a fluid sealing function. The matrix may be a glue, and even more beneficially the matrix may be epoxy.

The turbine may further comprise a cable for enabling input and/or output of one or more of a power output line, a control system and power input to be connectable between the turbine and a remote location, wherein the electrical connection means comprises a first connection element provided for rotation with the turbine and a second connection element arranged to be non-rotating and connected to the cable to a remote location. The connection means is beneficially a slip ring arrangement.

The plurality of blades of the turbine are fixedly beneficially mounted to a shaft, substantially preventing relative movement therebetween.

A thrust bearing assembly is preferably also provided, arranged to control deflection of the turbine in a direction generally parallel to the axis of rotation assembly, the turbine further comprising a braking means arranged to cause braking of the component of the thrust bearing assembly. The thrust bearing assembly beneficially includes a braking means.

According to a second aspect of the present invention, there is a marine turbine generator arranged to be supported in a fluid flow, the turbine further comprising a cable enabling electrical input and/or output of one or more of an output power line, a control system and power input to be connectable between the turbine and a remote location, wherein the electrical connection means comprises a first connection element provided for rotation with the turbine and a second connection element arranged to be non-rotating and be connected to the cable to a remote location.

The connection means is preferably a slip ring arrangement.

According to a third aspect of the present invention, there is a marine turbine support, the support arranged to be fixedly connected to the ground in a fluid flow, the support comprising an elongate member having a top end and a bottom end, the portion of the support adjacent the top end having a reduced cross-sectional area to the bottom end.

The reduced cross-sectional area is beneficially adjacent the height of the blades of a turbine when in use.

Even more beneficially, there is a marine turbine assembly including a turbine and a support, the support arranged to contact the turbine providing an operational engagement therebetween.

According to a fourth aspect of the present invention, there is a turbine assembly including a turbine and a support arranged to support the turbine in a fluid flow, the turbine and support comprising complementary male and female engaging portions such that when the turbine is lowered onto the support, the male and female portions contact thereby providing an operational engagement therebetween.

The male engaging portion may have a bearing arranged to communicate with the female portion including an elongate member arranged to guide the body of the male engaging portion into the female engaging portion, the elongate member extending beyond the bearing of the male engaging portion.

The elongate member beneficially has a longitudinal length greater than the transverse length. The elongate member is beneficially of a greater length than the rest of the male engaging portion. The female engaging portion is beneficially generally conical. The opening of the female engaging portion beneficially comprises a diameter of approximately three metres.

According to a fifth aspect of the present invention, there is a generator for a marine turbine, the generator comprising a rotor arrangement and a stator arrangement, the generator being arranged to be flooded with the fluid in which the marine turbine is immersed.

According to a sixth aspect of the present invention, there is a generator for a marine turbine having a rotor and a stator, wherein the rotor and/or the stator is provided with a matrix, layer and/or coating to provide a fluid sealing function.

According to a seventh aspect of the present invention, there is a turbine comprising a shaft having blades connected thereto and a generator arranged such that a force applied to the blades causes rotation of the shaft thereby activating the generator, the turbine further comprising an axial load bearing assembly including a braking means arranged to control rotation of the shaft.

The braking means may include a braking surface onto which a brake acts.

It will be appreciated that each aspect and preferred features of each aspect may be provided in combination.

Aspects of the present invention will now be described by way of example only with reference to the accompanying drawings.

### BRIEF DESCRIPTION OF THE DRAWINGS

FIG. 1 is a schematic side view of a turbine according to an exemplary embodiment of the present invention.

FIG. 2 is schematic cross-sectional view of a turbine according to an exemplary embodiment of the present invention.

FIG. 3a is a schematic side view of a turbine located on a support on, for example, the sea bed, and FIG. 3b is a schematic cross sectional view of the turbine and support components independently.

FIG. 4 is a schematic cross-sectional view of a turbine according to an exemplary embodiment of the present invention wherein the connection between the support and turbine is offset relative to the turbine body.

### DETAILED DESCRIPTION OF THE PREFERRED EMBODIMENTS

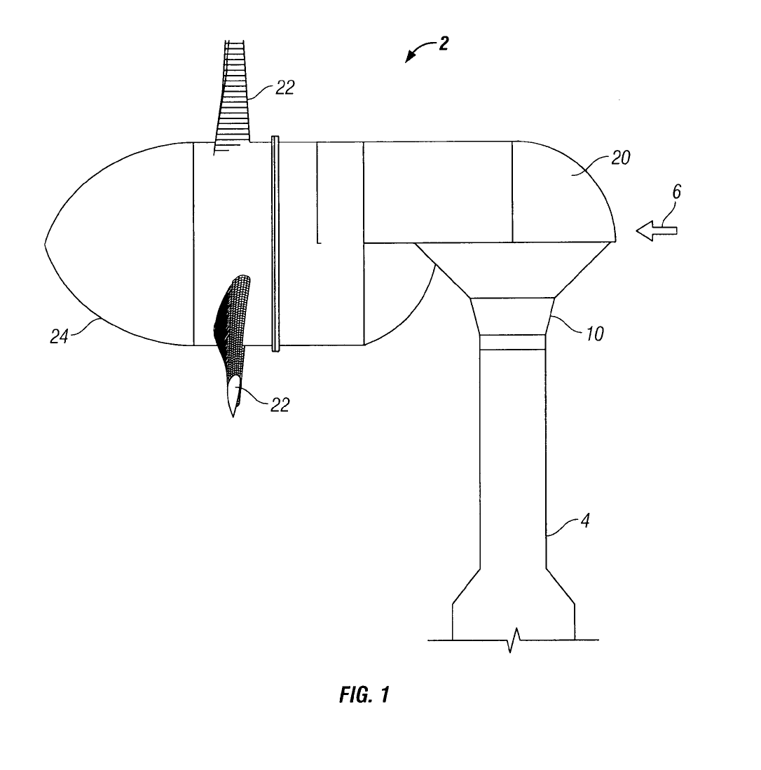

Referring to FIG. 1, there is schematically shown a turbine 2 mounted onto a support 4 which is located in a fluid flow indicated by arrows 6. Provision of a downstream marine turbine is beneficial as it enables a less complex system to be utilised although provides one disadvantage in that the turbine cowling and support may cause disruption of the fluid flow, and provisions are taken to reduce this effect. The system according to aspects of the present invention requires no active control of the orientation of the turbine in the flow and the turbine can rotate automatically to align with the optimum direction in respect of the fluid flow, optimising energy transfer. If such an apparatus is used in a tidal environment such as the sea then depending on the direction of the tide will depend on the direction in which the fluid is flowing. Accordingly, the turbine must be able to rotate through 180 degrees to achieve transfer of energy in both directions. Even more beneficially, the turbine should rotate through 360 degrees in order to optimise the energy extraction. This will described in more detail further on in the specification.

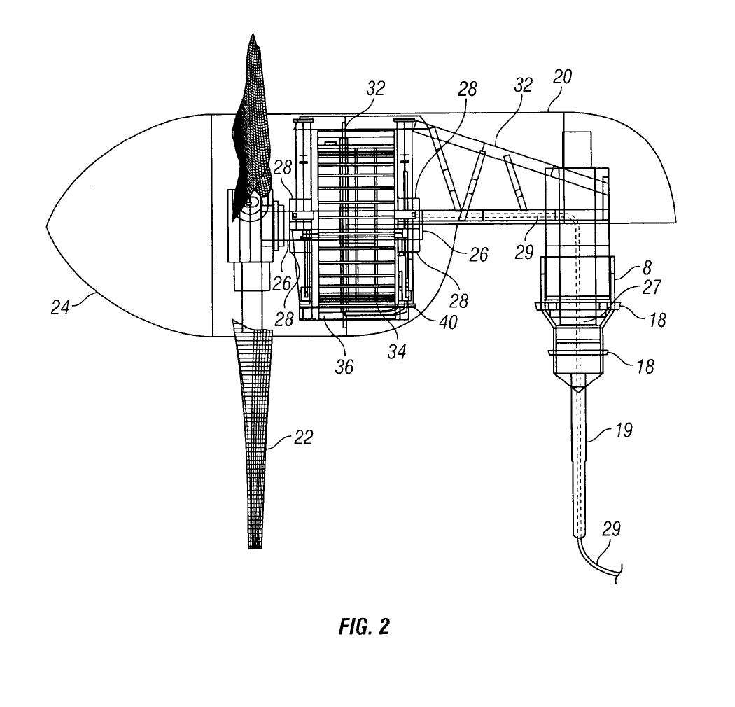

Referring to FIG. 2 there is a cross-sectional schematic diagram of a turbine according to an exemplary embodiment of the present invention. It should be noted that the support structure for the turbine is not shown with respect to this Figure. The turbine comprises a plurality of blades 22 arranged to rotate on a shaft 26. The shaft rotates on forward and rearward bearings 28 which are mounted within a chassis 32. A thrust bearing (not shown) may also be provided which acts to handle axial forces along the centre line of the shaft. These forces are as a result of the fluid flow pushing against the blade. The turbine further comprises a generator having a rotor 34 (including magnets) and stator 36 (including coils) wherein the rotor rotates with the shaft adjacent the stationary stator 36 (although it will be appreciated that this may be reversed). A cable (not shown) connects all of the coils and this is lead into a main cable 29 which includes fibre optics and an external power input. The chassis 32 extends towards the forward end of the turbine and is fixedly connected to the plug arrangement 8. A cowling 20 is arranged to cover the components of the turbine and a tail cone 24 is positioned at the rearward end of the turbine in order to improve fluid flow around the turbine. In such an arrangement no gearbox is necessary due to utilisation of a low rotational speed direct drive permanent magnet generator. The rotor generally consists of a central hub and a radially spaced concentric rim portion with rotor magnetic elements mounted upon it. A plurality of elongate tension members extend generally between the hub and the rim, maintained in tension so as to maintain the rim in compression. This is a beneficial arrangement to be employed in a direct drive generator where the rotor is directly linked to the shaft.

Referring to FIG. 2, there is a brake system 40 which acts to brake the rotation of the shaft as required. In the embodiment shown in respect of FIG. 2, the brake acts on a disc adjacent to the forward bearing, which in this embodiment the bearing is arranged such that it may withstand both axial and radial loads. The type of bearing used in an exemplary embodiment of the present invention are polymer bearings which generally are only able to withstand radial loads and as such may include a further taper bearing arranged to withstand the axial force component. Alternatively, an additional bearing set may be utilised commonly known as a thrust bearing arranged to withstand axial loads. This is a requirement in a downstream turbine to counteract the force on the blades which act to push the blades from the turbine.

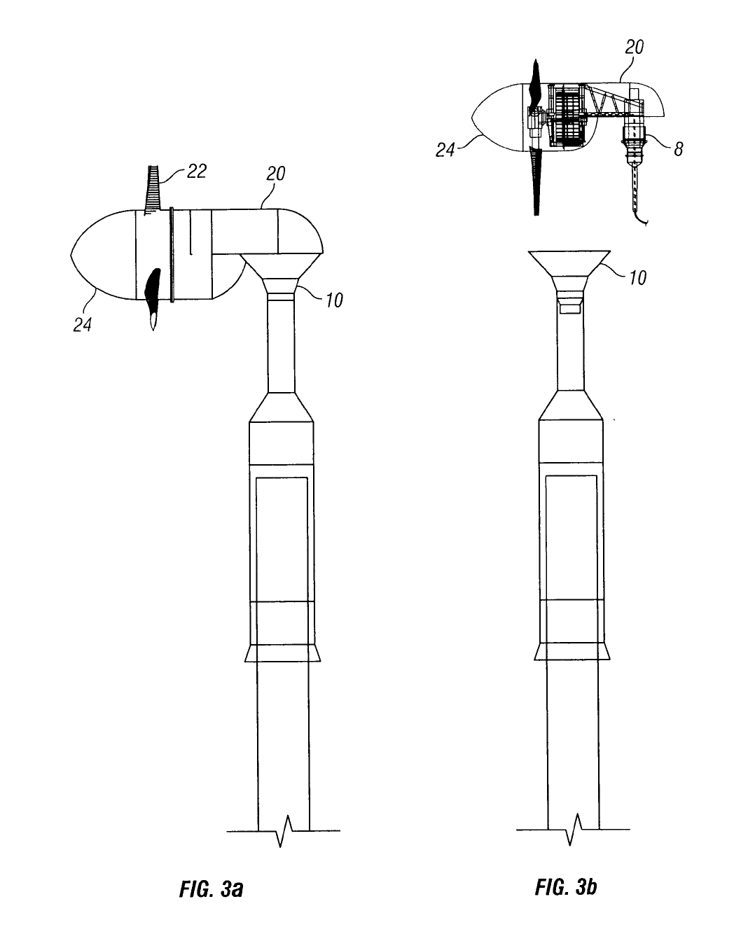

The turbine 2 and support 4 include complementary male and female engaging portions which may be seen in detail with respect to FIGS. 2 to 4. The turbine 2 preferably comprises the male engaging portion 8 which is arranged to be received by the female engaging portion or socket 10. The male engaging portion 8 may be generally termed a plug 8 and will subsequently be referred to using this terminology. The support 4 may generally comprise a rigid structure which can be installed into the desired location in the fluid flow. The base generally only comprises components that do not require servicing, and as such may be fixedly attached to a location such as on the sea bed. The socket 10 is of a generally increasing diameter and in a preferred embodiment comprises a cylindrical portion 12, a first frustroconical portion 14, and a second frustroconical portion 16 wherein the second frustroconical portion is provided with a relaxed sidewall angle as clearly shown in respect of FIG. 3. The shape and in particular the angle of the plug 8 and support 10 interface are chosen such that any expected combination of vertical and horizontal loads during operation of the turbine does not exceed the friction force between the interfaces such that all components remain in position. The opening of the socket 10 is of a significantly greater diameter than the diameter of the plug 8. This is because the turbine is generally lowered onto the support in the fluid flow and as such accuracy is limited to approximately three metres. This is known in the field of technology as “Dynamic Positioning”. This means that the plug may swing through about three metres as it is lowered towards the support. Accordingly, the socket 10 must be of sufficient diameter such that contact is relatively easily achieved. In addition to this, and to reduce the possibility of one of the rotor blades coming into contact with the support, the plug 8 further comprises an elongate member 19 extending from the lower portion of the plug which ensures that the plug 8 locates safely into the support 10. The elongate member 19 acts to guide the plug of the turbine to nest appropriately in the socket, and is of significant length compared to the length of the plug. It is clear that it would be extremely detrimental to the overall assembly if the rotor blade came into contact with the support 10.

A lifting arrangement (such as a simple hook or loop) is provided arranged such that the turbine can be lifted and lowered onto the support. The lifting point is directly above the elongate member and the centre of gravity of the turbine in both air and water is designed to be in the same or near vertical line. In the event that the centre of gravity in air and that in water are in different places, a system is used to adjust the position of the lifting point accordingly such that the system is balanced in air and water.

Although a preferred embodiment is one in which the support includes socket 10, it will be appreciated that in an alternative embodiment the support may comprise the plug 8 and a socket may be lowered onto a plug fixedly connected to the sea bed.

The plug 8 is also generally cone shaped and in particular in the vicinity of the tip to aid installation. The outer surface of the plug 8 comprises an outer varying surface 18 which is a compressible material such as rubber thereby allowing for misalignment when locating the plug 8 into a socket 10, and will also allow for manufacture intolerances and changes to the surface that may occur during use, such as wear, corrosion and marine growth. Additionally or alternatively, a splined arrangement may be provided between the outer surface of the plug 8 and the inner surface of the socket 10 which further resists rotation therebetween. However, it will be appreciated that the more complex interface provided between the plug 8 and socket 10 reduces the ability for allowing misalignment, marine growth etc. Locating shims (not shown) may be used on the outer surface of the plug 8 to allow for less rigorous tolerances in the dimensions of the plug and to aid in positioning of the plug 8 in the socket 10. The inner part of the plug 8 may contain ballast which is provided to orientate the structure correctly and will act as a keel for the overall structure during transportation. Once the plug 8 is located into the socket 10, an electrical connection between the plug 8 and socket 10 is made.

Inside the plug 8 is provided a section that rotates relative to the plug 8 on a set of yaw bearings (not shown). The degree of friction in the yaw bearings is significantly less than the frictional force between the plug and socket, and the turbine is connected to this rotationally mounted section. This therefore enables the turbine to rotate relative to the fluid flow and thus can be aligned in the water such that the optimal amount of energy may be transferred from the flowing fluid into electrical energy. By housing these yaw bearings as part of the plug, the servicing is easier as the entire system may be lifted as one independent body rather than the requirement to employ divers to carry out servicing which is expensive and dangerous and is limited in the type of repairs that may be carried out. A significant advantage of this plug and socket system is that the turbine does not have to be aligned in any particular direction on deployment from a crane mounted on a vessel. This reduces the complexity of installation and reduces installation time and hence cost. It will be appreciated that if necessary further fixing systems may be utilised such as, for example, a hydraulic clamp or pin which would act to prevent the plug 8 and socket 10 coming apart in use, however this is not essential. Some residual friction in the yaw bearings is beneficial to damp out oscillations due to dynamic effects such as turbulence in the water. However, in this arrangement the blades yaw into a downstream position in the correct orientation to the flow without controllers or any other intervention.

The bearing sets as described are preferably water lubricated polymer bearings which have a relatively high degree of friction meaning that the turbine will not rotate uncontrollably relative to the support. Specific suitable materials are envisaged to be composites, resin impregnated cotton or phenolics as examples having suitable properties. This provides a significant benefit in that sealing of the bearings is not required and the requirement for lubrication materials is removed. A hydrodynamic film forms on the bearing surfaces in use aiding lubrication and reducing friction. Utilising sufficient size of bearing therefore aids in reducing wear on the bearings.

A beneficial feature of the present invention is the ability for the turbine to rotate through 360° relative to the socket 10 and the component of the plug that rotates on the set of bearings 18. A problem with prior art arrangements is that cable tangling often occurs as the cable which is linked from the turbine to a remote location must pass via any connection system between plug and socket. The cable generally includes fibre optics, a power out and an auxiliary power in and can include multiples of each of these. Generally, known arrangements are often used such as an end stop, a curved bearing surface or some other complex cable handling system which can be arranged to prevent the turbine from rotating through 360°. A motor is often used in upstream turbines to prevent such rotation. This will enable rotation through close to 360°, however, it is beneficial for optimum energy transfer and load reduction that 360° rotation is achieved. For this purpose, a slip ring 27 arrangement is a preferred solution which is a device utilised to conduct current from a rotating part to a non-rotating part. A slip ring may consist of, for example, a conductive circle or bond mounted on a shaft and insulated from it. An electrical connection from the rotating part of the system is made to the ring. Fixed contacts or brushes run in contact with the ring thereby transferring electrical power or alternatively signals to the static part of the system. Referring again to FIG. 2, a cable 29 leads from the generator to be passed away from the system through the plug and socket to be directed to a desired location. Power transmission is AC, but high voltage DC may be utilised removing the need for offshore power conversion. The split ring 27 will be located in order that the turbine, which rotates with respect to the socket and lower position of the plug, enables the power to be transferred through the cable 29 without the problems associated with the cable 29 being wound around the support. In the embodiment shown, the cable 29 beneficially is lead out through the support itself. Accordingly, the cable in the rotating part of the system is connected to a split ring on the axis of rotation of the turbine relative to the support, enabling rotation between turbine and support without associated cable tangling issues. A further disadvantage of a system in which continuous rotational capability is not allowed is that the support and may require initial orientation on deployment.

Referring back to FIG. 1, there is a cowling 20 arranged to cover the turbine and the turbine has a plurality of blades 22. At the downstream end of the cowling 20 there are the rotating turbine blades and a rotating tail cone 24 which act to reduce hydrodynamic interference from the cowling. The length of this tail cone can be extended so that it acts to move the centre of drag of the system backwards, away from the pivot, further improving the system's ability to turn into the correct orientation with respect to the fluid flow. The cowling 20 has openings to allow seawater to flood into the components of the generator. These openings may be covered by some sort of filter system which is resistant to debris and animal life such that the internals of the arrangement are not clogged or damaged by such debris. The enabling of fluid next to the moving parts has beneficial dynamic properties providing ‘added mass’ to the dynamic rotating system which results in lower natural frequencies and higher damping. Further benefits of a “wet running system” are that careful sealing is not required, a pressure vessel is omitted, no bilge pump and cooling system is required, and no lubrication of bearings is necessary. The shaft 26 (shown in FIGS. 2 and 3) is open to the fluid flow and rotates on bearings 28. These bearings are beneficially water-lubricated composite bearings and may include two sets of shaft bearings 28 and a thrust pad 30. In this environment such bearings are more robust than a standard rolling element bearing and further reduce complexity of the system. There is a known wear rate with such bearings and they may be replaced at planned maintenance intervals which may be simply achieved by removing the turbine from the location onto a vessel where maintenance can be carried out on the vessel or alternatively the turbine may be taken to land and subsequently may be serviced accordingly.

It will be appreciated that aspects of the generator will become wet during use and it will be appreciated that the coils and/or magnets should be sealed from communication with the water which is likely to be salt water if the arrangement is used in a tidal environment. Accordingly, the coils and/or magnets are encased in a matrix. The matrix, for example, comprising a polymer such as epoxy resin. As some ingress of water into epoxy resin is possible, a layer may additionally be provided within the resin such as Teflon to prevent any water from contacting the coil and/or magnet. Alternative embodiments may be a container having the coil and/or magnet therein however a matrix of a polymeric material is preferred. A coating may alternatively be applied to the coil and/or magnet, again preferably of a polymeric material in order that a barrier is provided between the coil and/or magnet and the fluid environment. In a preferred embodiment, the coil and/or magnet may be encased in a polymeric material such as epoxy and subsequently encased in any metallic material such as a metal box. This provides, in effect, double protection for the magnet and/or coils. Each of coils and/or magnets is beneficially encased in an independent matrix of glue and case.

For safety purposes, the turbine requires a brake system. This is also beneficial in maintenance of the system in order that it can be shut down prior to being removed for maintenance purposes without being dangerous for the engineers. One option is to use ‘cogging’ which basically means shorting the generator in order to park the system for this purpose. However, the system would also require a safety brake which may be a spring-loaded, hydraulically opening brake working onto a brake disc. This disc may be positioned inside the generator. Alternatively, and in order to reduce complexity of the system, a disc connected to the thrust bearing 30 may be used as a braking surface as previously described. If this is to be used to include a braking surface, it will be beneficial to increase the diameter and provide a disc brake arranged to act thereon which is, in a normal configuration, held open by a hydraulic system. When the hydraulic pressure is released the brake is closed by power springs. To release the brake, an actuator is provided which is opened and high pressure hydraulic fluid flows into the cylinder from an accumulator. This system provides an advantage in that it does not require a hydraulic pump and has very little complexity. However, it does have the disadvantage of a limited number of brake operations before the accumulator needs recharging. It will be appreciated, however, that this maintenance may be carried out when, for example, the bearings are replaced or the system is serviced.

Referring again to FIG. 1, the support 4 is clearly shown which is extended and fixedly attached to the ground which may be the seabed. Due to the downstream location of the rotor blades 22, there will be some interaction between the flow of fluid between the blades and the tower, in particular with any vortex shedding from the tower. In order to minimise these effects, the tower section directly in front of the blades has a reduced diameter compared to the remaining, lower section of the tower. This maintains strength with respect to the support whilst providing an optimum level of strength compared to fluid flow effects caused by the upper portion of the support in the direct flow path of the blades.

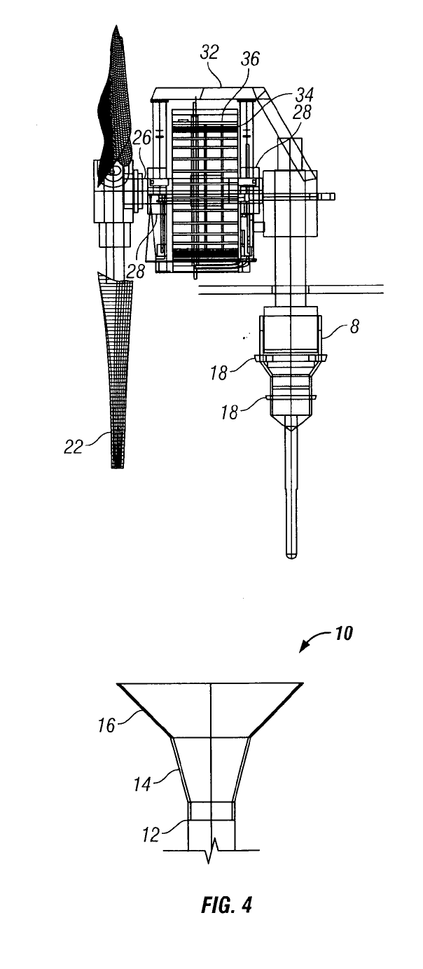

FIGS. 3 and 4 show alternative embodiments of the present invention whereby the plug 8 and socket 10 are located in line with respect to the generator as in FIG. 2 and offset with respect to the generator as indicated in FIG. 3. The vortex shedding from the tower will have an effect on the friction required in the bearings 18 of the plug 8 about which the turbine rotates. The friction may be increased in order that the effect of the vortex shedding from the tower and the frequency of the blades rotating and also of the shaft rotating, is sufficiently damped by the bearings. This will be beneficial as it will extend bearing life and ensure survivability of the system. This is clearly beneficial when compared with floating systems moored on chains.

Referring to FIG. 4, there is an alternative embodiment of the present invention wherein a turbine is indicated having a plug 8 which is offset relative to the body of the turbine. In this figure, the cowling of the turbine has not been shown nor has the tail cone. An advantage of offsetting the plug with respect to the turbine body is that the inference of the fluid flow on the blades is believed to be reduced.

Aspects of the present invention have been described by way of example only and it will be appreciated by a person skilled in the art that modifications and variations may be made without departing from the scope of the amended claims. In particular, it will be appreciated that features of each aspect of the present invention may be combined with features of other aspects of the present invention without departing from the scope of protection afforded.

1. A marine turbine arranged to be supported in a fluid flow on a support, the turbine comprising:
a rotatably mounted shaft carrying a plurality of blades, and at least one bearing arranged to support the shaft and a generator arrangement including a rotor coupled with the shaft, and a stator,
wherein, the turbine, when in use, is arranged such that the blades are located downstream of the turbine body, the turbine further comprising means to enable relative rotational movement between the support and the turbine such that the turbine aligns with the fluid flow, and wherein the at least one bearing is configured to be in contact with the fluid.

2. A turbine according to claim 1, wherein:
the at least one bearing is a polymer bearing.

3. A turbine according to claim 1, wherein:
forward and rearward bearing assemblies are located forward and rearward of the generator arrangement, the forward bearing assembly located further from the blades than the rearward bearing.

4. A turbine according to claim 1, wherein:
a braking means is provided to control rotation of the shaft.

5. A turbine according to claim 4, wherein:
the braking means is arranged to communicate with a forward bearing assembly.

6. A turbine according to claim 3, wherein:
the forward bearing assembly includes a bearing and brake disc.

7. A turbine according to claim 1, further comprising:
a cowling arranged to cover a plurality of the components of the turbine, the cowling having at least one aperture therein for enabling fluid to enter the cowling.

8. A turbine according to claim 7, further comprising:
filter means arranged to filter objects from the fluid preventing entry to the at least one aperture.

9. A turbine according to claim 1, wherein:
the turbine is arranged such that, when in use, fluid floods the separation between the rotor and the stator of the generator arrangement.

10. A turbine according to claim 1, wherein:
the rotor and the stator of the generator arrangement are provided with a matrix, layer and/or coating to provide a fluid sealing function.

11. A turbine according to claim 10, wherein:
the matrix is a glue.

12. A turbine according to claim 11, wherein:
the matrix is epoxy.

13. A turbine according to claim 1, further comprising:
a cable for enabling input and/or output of one or more of a power output line, a control system and power input to be connectable between the turbine and a remote location, wherein the electrical connection means comprises a first connection element provided for rotation with the turbine and a second connection element arranged to be non-rotating and connected to the cable to a remote location.

14. A turbine according to claim 13, wherein:
the connection means is a slip ring arrangement.

15. A turbine according to claim 1 wherein:
the plurality of blades of the turbine are fixedly mounted to a shaft, substantially preventing relative movement therebetween.

16. A turbine according to claim 1, further comprising:
a thrust bearing assembly arranged to control deflection of the turbine, in a direction generally parallel to the axis of rotation assembly, the turbine further comprising a braking means arranged to cause braking of the component of the thrust bearing assembly.

17. A turbine according to claim 16, wherein:
the thrust bearing assembly includes a braking means.

18. A marine turbine arranged to be supported in a fluid flow, the turbine comprising:
a generator including a rotor for rotation with the turbine, electrical connection means enabling electrical input and/or output of one or more of an output power line, a control system and power input to be connectable between the turbine and a remote location, the electrical connection means including a first connection element provided for rotation with the rotor of the generator and a second connection element arranged to be non-rotating.

19. A turbine according to claim 18, wherein:
the first connection element is a slip ring arrangement.

20-28. (canceled)

29. A generator for a marine turbine, the generator comprising a rotor arrangement and a stator arrangement, the generator being arranged to be flooded with the fluid in which the marine turbine is immersed.

30. A generator for a marine turbine, the generator having a rotor and a stator, wherein the rotor and/or the stator is provided with a matrix, layer and/or coating to provide a fluid sealing function.

31. A generator according to claim 30, wherein:
the gap between rotor and stator is flooded when in use.

32. A turbine comprising:
a shaft having blades connected thereto and a generator arranged such that a force applied to the blades causes rotation of the shaft thereby activating the generator, the turbine further comprising an axial load bearing assembly including a braking means arranged to control rotation of the shaft.

33. A turbine according to claim 32, wherein:
the braking means includes a braking surface onto which a brake acts.

34. (canceled)
